(19) United States
(12) Patent Application Publication
(10) Pub. No.: US 2013/0266161 A1
(43) Pub. Date: Oct. 10, 2013

(54) Coil

(71) Applicant: Jing He, Shenzhen (CN)

(72) Inventor: Jing He, Shenzhen (CN)

(73) Assignees: AAC MICROTECH (CHANGZHOU) CO.,LTD., Changzhou (CN); AAC ACOUSTIC TECHNOLOGIES (SHENZHEN) CO.,LTD., Shenzhen (CN)

(21) Appl. No.: 13/858,294

(22) Filed: Apr. 8, 2013

(30) Foreign Application Priority Data
Apr. 9, 2012 (CN) 201220146629.3

(51) Int. Cl. H04R 25/00

(52) U.S. Cl. CPC H04R 25/00
USPC 381/312

(57) ABSTRACT

A coil for a transducer includes a pair of first sections, a second section connecting two ends of the first sections, and a third section connecting the other two ends of the first sections for forming a closed loop. The third section includes a pair of first stretch parts each extending from one first section toward the other stretch part, and a first concave part extending from the first stretch parts toward the second section.

### FIELD OF THE INVENTION

The present disclosure generally relates to the art of coils, more particularly to a hearing aid coil(HAC) used in a transducer for generating sound.

### Related Art of the Invention

As the market of portable consumer electronic products growing, electronic devices like mini speaker are widely used, and speakers combining hearing aid function are more and more demanded by users who are hearing-impaired. Usually a hearing aid coil is mounted in a speaker and helps users wearing hearing aid hear sound by electromagnetic induction with audiphones. A coil is generally made by winding metal wire or laser etching.

General speakers are regular shaped like square or circle, but nowadays, shapes of speakers are tend to be irregular. A regular coil may adapt a speaker well when the speaker is also regular, but when the speaker has an irregular shape, the regular coil cannot adapt to the speaker and it will limit the size of the coil thereby limiting the performance of the speaker.

Accordingly, it is necessary to provide an improved coil for solving the problems mentioned above.

### BRIEF DESCRIPTION OF THE DRAWINGS

FIG. 1 is a top view of a coil in accordance with a first exemplary embodiment of the present disclosure;

FIG. 2 is a top view of a coil in accordance with a second exemplary embodiment of the present disclosure.

### DETAILED DESCRIPTION OF THE EXEMPLARY EMBODIMENTS

Reference will now be made to describe two exemplary embodiment of the present disclosure in detail.

### Embodiment 1

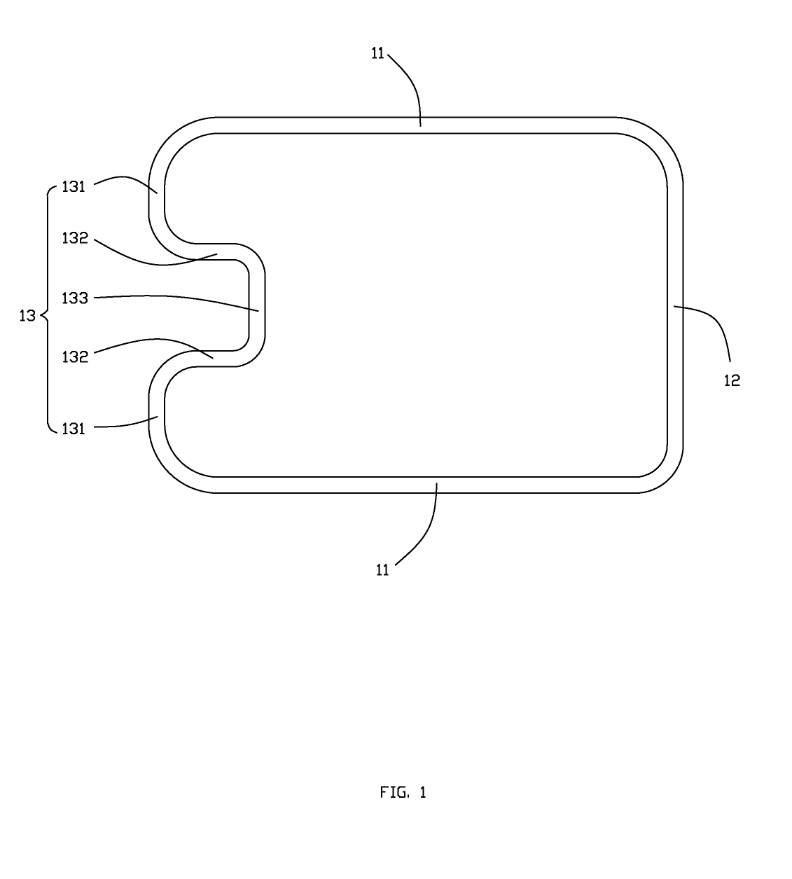

Referring to FIG. 1, a coil 1, in accordance with a first exemplary embodiment of the present disclosure, includes a pair of first sections 11 parallel to each other, a second section 12 connecting two ends of the first borders 11, a third section 13 connecting the other two ends of the first sections 11 forming a closed loop. The third section 13 includes a pair of first stretch parts 131 each extending from one first section 11 toward the other stretch part, a pair of second stretch parts 132 extending from the first stretch parts 131 toward the second section 12, and a first contact part 133 connecting the two second stretch parts 132. The second stretch parts 132 and the first contact part 133 cooperatively form a first concave part.

The second stretch parts 132 are substantially parallel to the first sections 11, and the first contact part 133 is substantially perpendicular to the first sections 11. The length of the first contact part 133 is smaller than the length of the second section 12, and the length of the first borders 11 is greater than the distance between the first contact part 133 and the second section 12.

### Embodiment 2

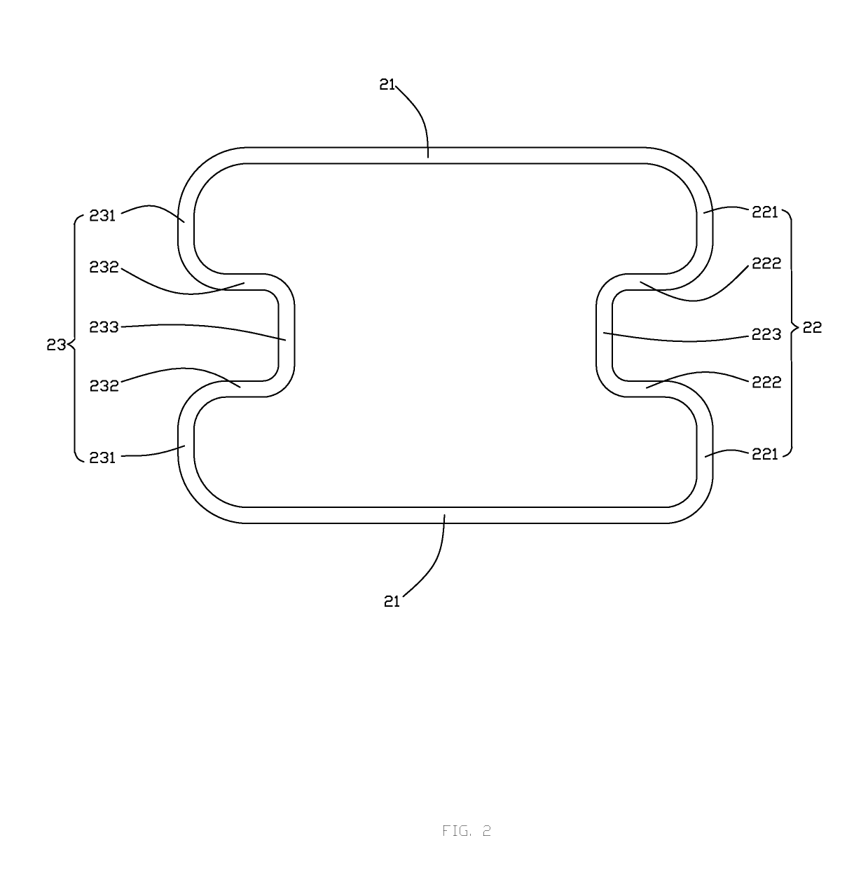

Referring to FIG. 2, a coil 2, in accordance with a second exemplary embodiment of the present disclosure, includes a pair of first sections 21 parallel to each other, a second section 22 connecting two ends of the first sections 21, a third section 23 connecting the other two ends of the first sections 21 for forming a closed loop.

Similar to Embodiment 1, the third section 23 includes a pair of first stretch parts 231 each extending from one first section 21 toward the other stretch part, a pair of second stretch parts 232 extending from the first stretch parts 231 toward the second section 22, and a first contact part 233 connecting the two second stretch parts 232. The second stretch parts 232 and the first contact part 233 cooperatively form a first concave part.

The second stretch parts 232 are substantially parallel to the first sections 21, and the first contact part 233 is substantially perpendicular to the first sections 21.

Different from Embodiment 1, the second section 22 includes a pair of third stretch parts 221 each extending from one first section 21 toward the other stretch part, a pair of forth stretch parts 222 extending from the third stretch parts 221 toward the third section 23, and a second contact part 223 connecting the two forth stretch parts 222. The forth stretch parts 222 and the third contact part 223 cooperatively form a second concave part.

The forth stretch parts 222 are substantially parallel to the first sections 21, and the third contact part 223 is substantially perpendicular to the first sections 21.

The length of the first contact part 233 equals to the length of the second contact part 223. The length of the second contact part 223 is smaller than the distance between the first sections 21, the length of the first section 21 is greater than the distance between the first contact part 233 and the second contact part 223.

Optionally, the coil could be symmetrical graphics.

When a speaker is irregular, coil 1 or coil 2 can adapt to the shape of the speaker, thereby optimizing the performance of the speaker.

While the present invention has been described with reference to specific embodiments, the description of the invention is illustrative and is not to be construed as limiting the invention. Various of modifications to the present invention can be made to the exemplary embodiments by those skilled in the art without departing from the true spirit and scope of the invention as defined by the appended claims.

What is claimed is:

1. A coil for a transducer generating sound, comprising:
a pair of first sections,
a second section connecting two ends of the first sections,
a third section connecting the other two ends of the first sections for forming a closed loop, wherein
the third section includes a pair of first stretch parts each extending from one first section toward the other stretch part, and a first concave part extending from the first stretch parts toward the second section.

2. The coil as described in claim 1, wherein the first concave part includes a pair of second stretch parts extending from the first stretch parts toward the second section, and a first contact part connecting the two second stretch parts.

3. The coil as described in claim 2, wherein the first sections are substantially parallel to each other, the second stretch parts are substantially parallel to the first sections, and the first contact part is substantially perpendicular to the first sections.

4. The coil as described in claim 3, wherein the length of the first contact part is smaller than the distance between the first sections, and the length of the first section is greater than the distance between the first contact part and the second section.

5. The coil as described in claim 1, wherein the second section includes a pair of third stretch parts each extending from one first section toward the other stretch part, and a second concave part extending from the third stretch parts toward the third section.

6. The coil as described in claim 5, wherein the second concave part includes a pair of forth stretch parts extending from the third stretch parts toward the third section, and a second contact part connecting the two forth stretch parts.

7. The coil as described in claim 6, wherein the first sections are substantially parallel to each other, the forth stretch parts are substantially parallel to the first sections, and the second contact part is substantially perpendicular to the first sections.

8. The coil as described in claim 7, wherein the length of the second contact part is smaller than the distance between the first sections, and the length of the first section is greater than the distance between the first contact part and the second contact part.

9. A coil, comprising four sections forming a closed loop, among the sections, a selected section forms a concave portion toward another section opposed to the selected section.

10. The coil as described in claim 10, wherein the concave portion includes a pair of stretch parts extending from the selected section toward the section opposed to the selected section, and a contact part connecting the two stretch parts.
